(19) United States
(12) Patent Application Publication
(10) Pub. No.: US 2014/0132606 A1
(43) Pub. Date: May 15, 2014

(54) Three-dimensional man-machine interaction display and control method for power grid operation monitoring

(71) Applicant: Beijing Kedong Electric Power Control System Co., Ltd, Beijing (CN)

(72) Inventors: Wen WANG, Beijing (CN); Lin ZHAO, Beijing (CN); Xuewei SHANG, Beijing (CN); Pai SUN, Beijing (CN); Zan WANG, Beijing (CN); Jianming YU, Beijing (CN); Liang ZHANG, Beijing (CN); Fenlan JIN, Beijing (CN); Shaoxin HU, Beijing (CN); Bo ZHANG, Beijing (CN); Liqing SUN, Beijing (CN); Xiaochun WANG, Beijing (CN); Lili WANG, Beijing (CN); Xin JIN, Beijing (CN); Yan LIU, Beijing (CN); Dachuang CHENG, Beijing (CN)

(73) Assignee: BEIJING KEDONG ELECTRIC POWER CONTROL SYSTEM CO., LTD, Beijing (CN)

(21) Appl. No.: 14/076,291

(22) Filed: Nov. 11, 2013

(30) Foreign Application Priority Data
Nov. 15, 2012 (CN) 201210459302.6

(51) Int. Cl. G06T 15/08

(52) U.S. Cl. CPC G06T 15/08
USPC 345/427

(57) ABSTRACT

The present invention discloses a three-dimensional man-machine interaction display and control method for power grid operation monitoring, which includes the following steps: drawing a picture in a two-dimensional plane by using a dual-buffer mechanism; reading the picture drawn in the two-dimensional plane, and drawing the picture in a three-dimensional space; detecting an interaction event in the three-dimensional space, and determining a type of a component in an operation panel; delivering the interaction event between the three-dimensional space and the two-dimensional plane, and processing the interaction event according to the component type; and reading the picture drawn by the component in the two-dimensional plane, and updating a corresponding image in the three-dimensional space. The present invention solves the problem of introducing the alarm images into the three-dimensional space.

### FIELD OF THE INVENTION

The present invention relates to a three-dimensional man-machine interaction display and control method, and more particularly to a three-dimensional man-machine interaction display and control method for the need of a power grid operation monitoring system.

### BACKGROUND OF THE INVENTION

In a power grid operation monitoring system, a dispatcher needs to deal with a great number of real-time parameters of running devices, and it is inevitable that omissions appear and treatment is not taken timely if monitoring is performed only with eyes. Only by setting an alarm system, the hidden troubles can be discovered and decisive measures can be taken to prevent accidents timely. At present, various power plants, transformer substations, substations, and communication stations all adopt the power grid operation monitoring system to implement intelligent and integrated management, and adopt the alarm system to improve and enhance security and stability of the power grid.

The existing alarm systems at home and abroad mainly show power grid data by traditional two-dimensional means, for example, show data in a two-dimensional plane with tables, curves, and bar charts. Users implement dispatching and interaction operation on the power grid also in the traditional two-dimensional plane. Only one image can be opened at a time in the two-dimensional plane, and it is inconvenient to perform operation when multiple images need to be viewed. In the other hand, the existing power grid data cannot be shown in a form of a three-dimensional image, and particularly, in lack of effective visible means, various computing results and analysis results cannot be efficiently shown. Especially, the existing alarm system cannot convert the two-dimensional image into the three-dimensional image, lacks the visible means to perform information mining and intelligent alarm, and cannot implement dispatching and interaction operation on the power grid in the three-dimensional image in real time.

With the development of computer graphics technologies, three-dimensional visible technologies are gradually introduced into the power grid operation monitoring system, which provide more convenient and flexible man-machine interaction means for the power grid dispatching. However, to display the alarm information in the three-dimensional space, OpenGL language needs to be applied so as to implement drawing and operation in the three-dimensional space. When the OpenGL language is used to perform direct drawing, it is required to re-design and re-arrange all images, and develop and draw a mouse operation response event; the existing displayed images cannot be inherited, so the work load is heavy.

### SUMMARY OF THE INVENTION

In view of the disadvantages in the prior art, the technical problem to be solved in the present invention is to provide a three-dimensional man-machine interaction display and control method for power grid operation monitoring. The method can directly inherit the existing images, and implement fast drawing in a three-dimensional space.

To achieve the foregoing invention objectives, the present invention adopts the following technical solutions:

A three-dimensional man-machine interaction display and control method for power grid operation monitoring includes the following steps:

drawing a picture in a two-dimensional plane by using a dual-buffer mechanism;

reading the picture drawn in the two-dimensional plane, and drawing the picture in a three-dimensional space;

detecting an interaction event in the three-dimensional space, and determining a type of a component in an operation panel;

delivering the interaction event between the three-dimensional space and the two-dimensional plane, and processing the interaction event according to the component type; and

reading the picture drawn by the component in the two-dimensional plane, and updating a corresponding image in the three-dimensional space.

Preferably, the step of drawing a picture in a two-dimensional plane by using a dual-buffer mechanism further includes:

generating a buffer area in a memory according to dimensions of the three-dimensional space;

generating a graphic handle drawn according to a picture in the buffer area; and

drawing a graphic object of the component in the buffer area through the graphic handle.

Preferably, the step of drawing a picture in a two-dimensional plane by using a dual-buffer mechanism is implemented by using a dual-buffer mechanism of Java Swing component.

Preferably, the step of reading the picture drawn in the two-dimensional plane, and drawing the picture in a three-dimensional space further includes:

reading the picture drawn in the two-dimensional plane in real time by refreshing a thread, and updating image parameters according to dimensions of the three-dimensional space and displaying an image in the three-dimensional space.

Preferably, the step of detecting an interaction event in the three-dimensional space, and determining a type of a component in an operation panel further includes:

converting a coordinate in the two-dimensional plane into a coordinate in the three-dimensional space according to a viewport transformation inverse matrix, a projection transformation inverse matrix, and a model transformation inverse matrix;

projecting the coordinate in the three-dimensional space into the two-dimensional plane, and calculating a relative coordinate;

invoking an operation panel in the two-dimensional plane, and calculating the coordinate in the two-dimensional plane according to size of the operation panel in the two-dimensional plane; and

determining a component type according to the coordinate in the two-dimensional plane,

Preferably, the component type is one of a button, a radio button, a checkbox, a textbox, a list, a tree, a combo box, a table, or a tool bar.

Preferably, the step of delivering the interaction event, and processing the interaction event according to the component type further includes:

delivering the interaction event from the three-dimensional space to the two-dimensional plane according to a type of the interaction event, the calculated relative coordinate, the operation panel in the two-dimensional plane, and the component type;

performing conversion to carry on interaction operation on the component in the two-dimensional plane;

simulating a corresponding interaction operation in the two-dimensional plane; and

responding to the interaction operation and updating an picture drawn in the two-dimensional plane.

Preferably, the step of reading the picture drawn by the component in the two-dimensional plane, and updating an image in the three-dimensional space further includes:

reading the picture drawn in the two-dimensional plane in real time by refreshing a thread, and updating the image in the three-dimensional space by updating the parameters.

The three-dimensional man-machine interaction display and control method provided by the present invention overcomes the defects of complexity in direct drawing with OpenGL language, can directly inherit the existing image, and implements fast drawing in the three-dimensional space by the component, thereby introducing multiple alarm images into the three-dimensional space and solving the problem of introducing the alarm images into the three-dimensional space. The user can conveniently view the alarm images in the three-dimensional space, and perform comparison and analysis on the data in the images.

### BRIEF DESCRIPTION OF THE DRAWINGS

FIG. 1 is a schematic diagram of a man-machine interaction process in a three-dimensional space according to the present invention;

FIG. 2 is a schematic flow chart of processing a combo box according to the present invention;

FIG. 3 is a schematic flow chart of processing a drop-down box in the combo box;

FIG. 4 is a schematic flow chart of processing a table head;

FIG. 5 is a schematic flow chart of processing a table entity; and

FIG. 6 is a schematic flow chart of processing a keyboard input event in the table.

### DETAILED DESCRIPTION OF THE PREFERRED EMBODIMENTS

The present invention is further described in detail with reference to the accompanying drawings and the specific embodiments.

At present, the three-dimensional display technology is gradually applied in a power grid operation monitoring system, but the display method is single and lacks good compatibility with the original two-dimensional plane. A three-dimensional man-machine interaction display and control method provided in the present invention fully introduces types of displayed images currently existing in the power grid operation monitoring system into a three-dimensional space, so as to transform the display manner of power grid operation information from a static, two-dimensional and plane, and data-isolated manner to a dynamic, three-dimensional and stereoscopic, and graphics-continued manner.

The three-dimensional man-machine interaction display and control method provided in the present invention may be applied in a man-machine interaction alarm system of the power grid operation monitoring system. The man-machine interaction alarm system gives an alarm if an exception occurs in the operation and an operating state of the power system, and displays the exception in a form of various pictures on a screen to draw the user's attention, so that the user can timely take the corresponding measures. In the man-machine interaction alarm system, the following alarm events mainly occur:

1. alarm events in a system platform level: an exception in a run time environment (RTE), an exception in processing a significant procedure of each node in the power system, and an exception in a CPU load, a memory, and a network traffic of each node;

2. alarm events in a system application level: state changes of various state quantities in a supervisory control and data acquisition (SCADA) system, out-of-limit and recovery of various analog quantities, an operation result and a prediction result, a failure in delivery control, changes in an operating state of a telecontrol channel of a front-end system, changes in an operating state of a remote terminal unit (RTU) and changes in an operating state of a front-end machine, and an operating state failure during communication with another energy management system (EMS); and

3. alarm events of a hardware device: a node power failure, a printer failure, and a failure in significant hardware device.

After start, the man-machine interaction alarm system receives an alarm notification message sent from the power grid, processes the message, and stores the message in a data base. The man-machine alarm system displays data on an alarm image while stores the data, for example, displays a logic number, alarm content, time, an alarm level, and the like. Multiple pieces of alarm information probably exist for one failure, the user can view the multiple pieces of alarm information at the same time to perform analysis and determination, rapidly and correctly determine a failure reason, and distinguish a failure source alarm from a failure phenomenon alarm. The user can implement an interaction operation on the man-machine interaction alarm system according to the alarm information displayed on the screen, view more detailed information such as an alarm position, and compare and check the multiple images.

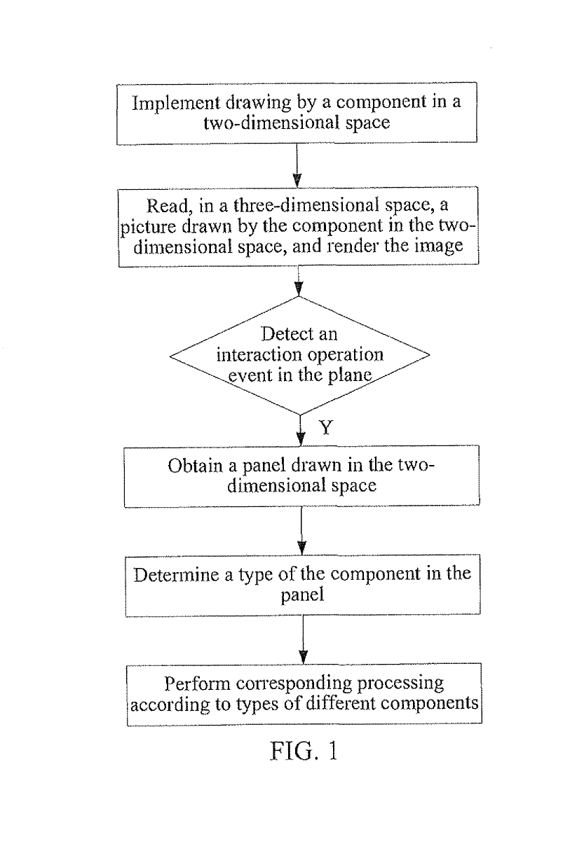

As shown in FIG. 1, the man-machine interaction alarm system acquires data from the power grid in real time, draws a picture in a two-dimensional plane according to the acquired power grid data and by using a dual-buffer mechanism of Java Swing component, and renders and displays the picture in a three-dimensional space. A user can perform an interaction operation with the man-machine interaction alarm system, and process and update, according to the interaction operation information, the image displayed in the three-dimensional space. To implement display in the three-dimensional space, the three-dimensional man-machine interaction display and control method provided by the present invention specifically includes the following steps. The man-machine interaction alarm system first generates a buffer area in a memory with a temporary file (Buffer Image); draws a picture in the temporal), file according to acquired real-time data; reads a picture (the initial picture drawn at this time is not displayed on the screen of the man-machine interaction alarm system) drawn by the buffer area in a two-dimensional plane and draws the picture in a three-dimensional space. Then, the alarm system reads real-time image information in the buffer area, and renders the image information read in the temporary file and displays the image in the three-dimensional space by updating image parameters (scissoring according to width and height of the plane); at this time, the user can perform, according to actual requirements, an interaction operation on the three-dimensional image displayed by the man-machine interaction device. Further, the alarm system detects and collects interaction operation information of the user, converts the interaction operation information into interaction operation information in the two-dimensional plane according to the current interaction operation event, obtains an operation panel drawn in the two-dimensional plane; determines types of components in the operation panel according to coordinate information of the currently obtained interaction operation event; performs different processing according to different types of the components, and implements an operation on the components in the two-dimensional plane; and gives a corresponding operation response and updates the image in real time. The three-dimensional man-machine interaction display and control method is described in detail in the following.

In the present invention, the man-machine interaction alarm system acquires data from the power grid in real time, and generates in a memory, according to the acquired power grid data, by using a dual-buffer mechanism of Java Swing component, and according to the width and height of the three-dimensional, space, a buffer area through a temporary file. Further, the man-machine interaction alarm system generates a graphic handle drawn by a picture in the buffer area, and draws, according to the acquired real-time data, images (the initial picture drawn at this time is not displayed on the screen of the man-machine interaction alarm system) corresponding to graphic objects of the components one by one in the temporary file through the graphic handle. The man-machine interaction alarm system reads the pictures drawn by the buffer area in the two-dimensional plane, and draws the pictures in the three-dimensional space. The man-machine interaction alarm system reads, in real time, the real-time image information drawn in the two-dimensional plane by refreshing a thread, and rendering the image information read in the temporary file by updating the image parameters (scissoring according to width and height of the plane) and display the image in the three-dimensional space.

After the man-machine interaction alarm system reads the picture drawn in the two-dimensional plane and draws the image in the three-dimensional space, the user can perform, according to actual requirements, interaction operations (the interaction operations are of multiple kinds, which are not described in detail herein) on the three-dimensional image displayed by a man-machine interaction device. The man-machine interaction alarm system further detects and collects the interaction operation information from the user, gives a corresponding operation response according to the current interaction operation, and updates the image in real time. Specifically, after detecting the interaction operation event in the two-dimensional plane, the man-machine interaction alarm system first converts a coordinate in the two-dimensional plane (that is, the screen) into a coordinate in the three-dimensional space sequentially according to a viewport transformation inverse matrix, a projection transformation inverse matrix, and a model transformation inverse matrix; projects the coordinate in the three-dimensional space into the two-dimensional plane to calculate a relative coordinate; then invokes an operation panel in the two-dimensional plane through an interface, and calculates a coordinate in the two-dimensional plane according to width and height of the operation panel in the two-dimensional plane; and finally, searches for the component type on the operation panel through recursion according to a coordinate value. The component may be any one of a button, a radio button, a checkbox, a textbox, a list, a tree, a combo box, a table, or a tool bar.

The man-machine interaction alarm system performs different processing according to the types of the components, and the processed components include a button, a radio button, a checkbox, a textbox, a list, a combo box, a table, a tree, or a tool bar. For the table component, it is required to process a table head, a table entity, and a scroll bar of the table respectively. In the procedure of processing the components, an interaction event is delivered from the three-dimensional space to the two-dimensional plane by an event delivery mechanism according to the type of the interaction event, the calculated relative coordinate, a control panel and component type in the two-dimensional plane; the interaction event is converted into an interaction operation to be performed on the component in the two-dimensional plane; a corresponding interaction operation is simulated in the two-dimensional plane; and a response is given to the interaction operation and the image drawn in the two-dimensional plane is updated. Herein, the delivering the interaction event includes, for example, responding to an operation event of a mouse. That is, after the image in the three-dimensional space detects a mouse event, a coordinate of a mouse operating point on the screen is converted into a relative coordinate in the two-dimensional plane after a series of transformations, corresponding processing of mouse operation event is performed according to the operation panel in the two-dimensional plane and the relative coordinate of the mouse in the two-dimensional plane.

In the following, interaction operations performed on a combo box, a drop-clown box popping up from the combo box, a table head, a table entity, keyboard inputting in the table, a tree component, and a tool bar are taken as an example. The following describes in detail the processing performed on various interaction events by the man-machine interaction alarm system after the operation events performed on various components in the three-dimensional space are delivered to the two-dimensional plane.

### Embodiment 1

The user performs an interaction operation on the combo box in the man-machine interaction alarm system.

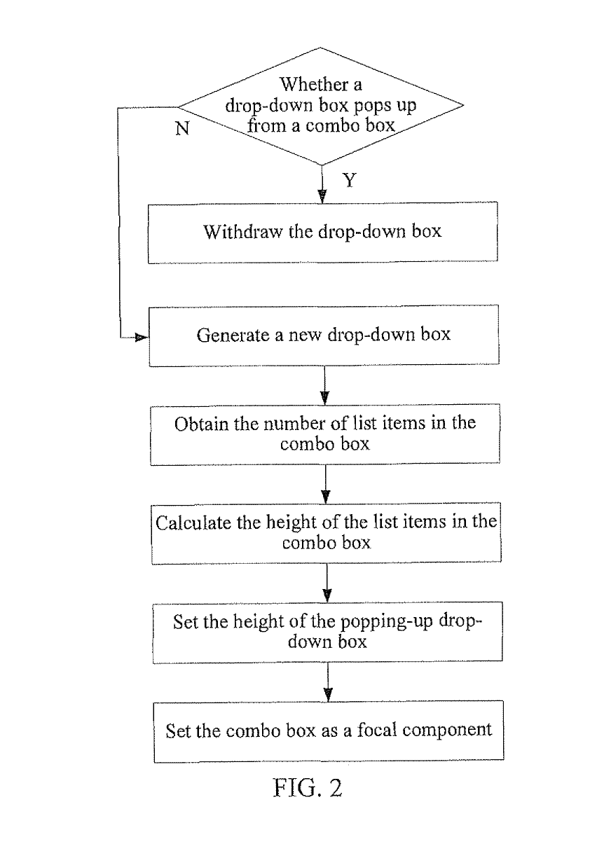

As shown in FIG. 2, when the user performs an interaction operation on the combo box in the man-machine interaction alarm system, the interaction event is delivered from the three-dimensional space to the two-dimensional plane. In the procedure of processing the combo box, an operation effect obtained in the two-dimensional plane cannot be achieved, and it is required to simulate a procedure of clicking the combo box, including the following steps:

1) first drawing an effect achieved when the combo box is pressed; then determining whether a drop-down box pops up; if not, generating a new drop-down box; and if yes, performing clicking again, and setting the drop-down box to be empty and withdrawing the drop-down box;

2) after the drop-down box pops up, correctly displaying in the drop-down box list items in the combo box, and calculating the height of the drop-down box; first obtaining the number of items in the list in the combo box, calculating the height of the frame according to an edge distance if the combo box and an edge distance of the drop-down box; and then subtracting the height of the frame from the height of the combo box component to obtain the height of list items in the combo box through calculation;

3) after the height of the list items is obtained through calculation, calculating the height of the popping-up drop-down box according to the height of the list items and the number of the list items; and setting the height of the popping-up drop-down box; and

4) after the height of the drop-down box is set, setting the drop-down box to be visible, and setting the combo box as a focal component.

### Embodiment 2

The user performs in a man-machine interaction alarm system an interaction operation on a drop-down box in a combo box.

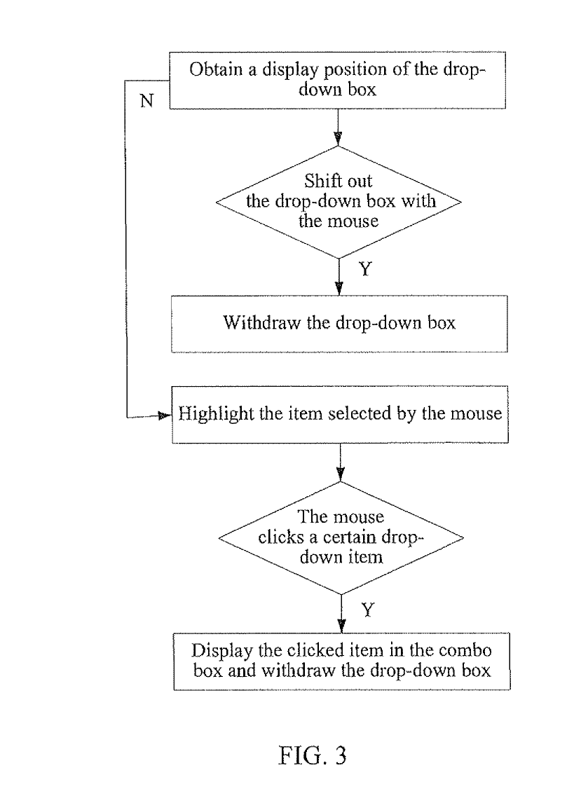

As shown in FIG. 3, when the user performs in the man-machine interaction alarm system an interaction operation on the drop-down box popping up from the combo box, the interaction event is delivered from the three-dimensional space to the two-dimensional plane. A procedure of processing a mouse selection event performed on the drop-down box popping up from the combo box includes the following steps:

1) calculating a display position of the drop-down box according to the position of the combo box and a root component where the drop-down box is located;

2) determining whether a position clicked by the mouse is within the range of the drop-down box; if not, setting the drop-down box to be empty, and withdrawing the drop-down box;

3) if the position clicked by the mouse is within the range of the drop-down box, determining a specific item, to which the position of the mouse shifts, of the list items in the drop-down box, and setting that the item to which the mouse shifts is selected; and

4) determining whether the mouse clicks the selected drop-down item; if yes, setting in the combo box that the item is selected, setting the drop-down box to be empty, withdrawing the drop-down box, and completing the operation performed on the combo box.

### Embodiment 3

The user performs an interaction operation on a table head in the man-machine interaction alarm system.

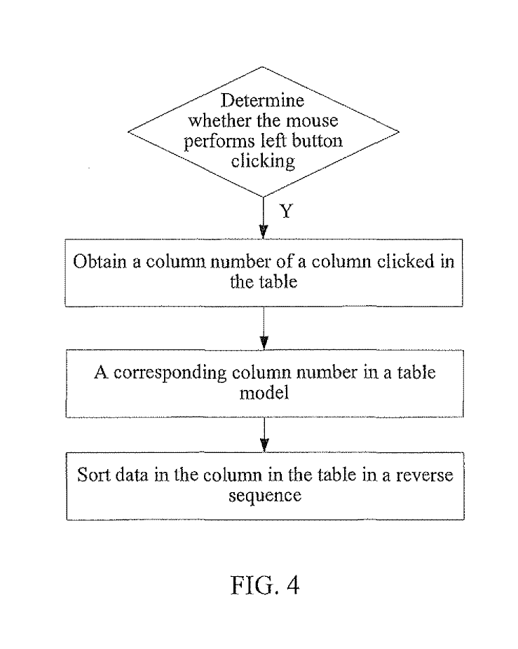

As shown in FIG. 4, when the user performs an interaction operation on the table head in the man-machine interaction alarm system, the interaction event is delivered from the three-dimensional space to the two-dimensional plane. A procedure of processing the table head includes the following steps:

1) determining whether a mouse operation is left button clicking; if yes, obtaining, according to a mouse clicking coordinate, a column number of a column clicked by the mouse in the table;

2) obtaining a corresponding column number in a table model according to the table column number of the column clicked by the mouse; and

3) sorting data in the corresponding column clicked by the mouse in the table in a sequence reverse to an original sequence of the data in the column in the table.

### Embodiment 4

The user performs an interaction operation on a table entity in the man-machine interaction alarm system.

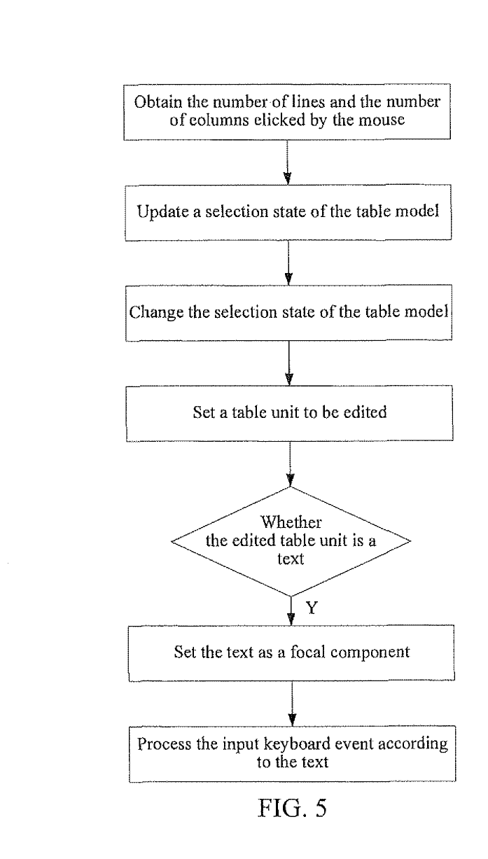

As shown in FIG. 5, when the user performs an interaction operation on the table entity in the man-machine interaction alarm system, the interaction event is delivered from the three-dimensional space to the two-dimensional plane. In a procedure of processing the table entity, a text field needs to simulate a keyboard event input in the two-dimensional plane, which includes the following steps:

1) obtaining, according to a mouse clicking coordinate, the number of lines and the number of columns in a table clicked by the mouse;

2) after obtaining the number of lines and the number of columns in the table clicked by the mouse, clearing a table unit previously selected in the table, and setting that a cell clicked by the mouse is a selected state;

3) changing the line number and the column number of a cell to be edited in the table, and starting to edit the cell;

4) if the table unit to be edited is not empty and has a text, setting a cursor of a text field to be visible, and setting the text as a new focal component; and

5) completing the edition on the table content.

### Embodiment 5

The user performs, in the man-machine interaction alarm system, an interaction operation on keyboard input in the table.

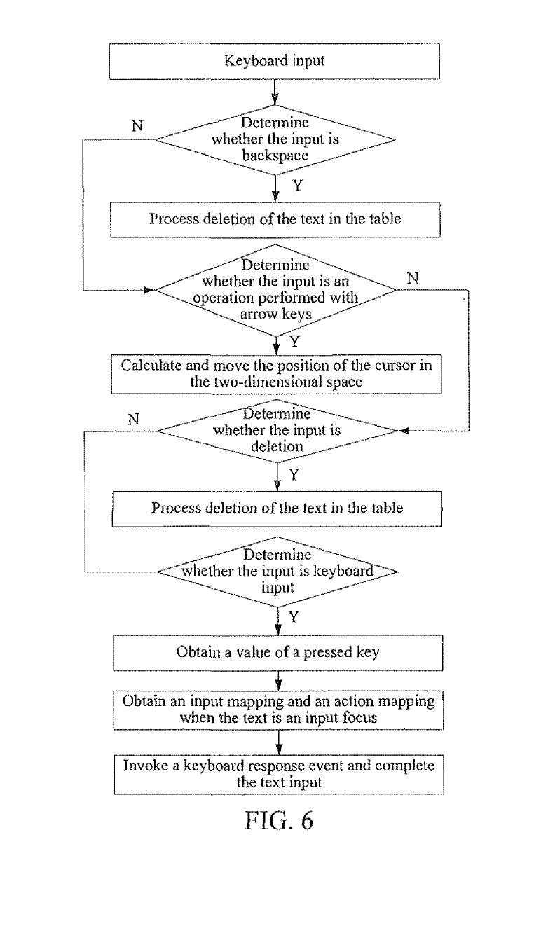

As shown in FIG. 6, when the user performs, in the man-machine interaction alarm system, an interaction operation on keyboard input in the table, the interaction event is delivered from the three-dimensional space to the two-dimensional plane. In a procedure of processing the keyboard inputting in the table, it is required to simulate a processing procedure of directly performing an operation on the table in the two-dimensional plane, which includes the following steps:

1) determining whether the input is backspace; if yes, determining positions of a caret and a mark, calculating the number of deleted characters, and performing deletion on the characters in the text in the table according to the number of the deleted characters;

2) performing processing on the operation performed with arrow keys; first obtaining a filter for restricting cursor position navigation; then calculating, according to the position and moving direction of the caret, a moving position of the cursor in the two-dimensional plane; obtaining a next visible position of the cursor with a position navigation filter, and setting the position of the cursor;

3) processing a deletion key, determining the positions of the caret and the mark, calculating the number of the deleted characters, and performing deletion on the characters in the text in the table according to the number of the deleted characters;

4) processing the keyboard input, determining whether a certain key is pressed, and obtaining a value, a letter, or a number of the pressed key;

5) mapping the input text into an object through input mapping, and mapping the object into an action through action mapping; and

6) determining whether the action is empty; if not, invoking a keyboard response event, and completing the text input.

### Embodiment 6

The user performs an interaction operation on a tree component in the man-machine interaction alarm system.

When the user performs an interaction operation on the tree component in the man-machine interaction alarm system, the interaction event is delivered from the three-dimensional space to the two-dimensional plane. In the procedure of processing the tree component, an operation on and a response to the tree are directly simulated in the two-dimensional plane, which includes the following steps:

1) first obtaining a tree component clicked by the Mouse, and obtaining a tree path object at the mouse clicking coordinate;

2) if the current tree component unfolds nodes identified by the path, folding a node identified by a designated path; otherwise, unfolding the node identified by the designated path;

3) selecting the node identified by the designated path, and setting the tree component as a new focal component; and

4) invoking a response event of a right-side image after the tree component is clicked.

### Embodiment 7

The user performs an interaction operation on a tool bar in the man-machine interaction alarm system.

When the user performs an interaction operation on the tool bar in the man-machine interaction alarm system, the interaction event is delivered from the three-dimensional space to the two-dimensional plane. In a procedure of processing the tool bar, an operation on and a response to the tool bar are directly simulated in the two-dimensional plane, which includes the following steps:

1) obtaining the number of components in the tool bar, obtaining a component at a mouse clicking position in the tool bar, and obtaining an index of the component;

2) determining whether the obtained component is a button; if yes, simulating a state when the button is pressed, and setting the component as a focal component; and

3) invoking a response event of the mouse clicking button.

In the present invention, an image operation in the three-dimensional space is delivered to the two-dimensional plane, and the corresponding interaction processing is completed; the image drawn in the two-dimensional plane is read in real time by refreshing a thread, and an image is drawn in the three-dimensional space by updating the parameters, thereby completing real-time update and synchronism of the image operation.

To sum up, through the embodiments of the present invention, the display of and the operation on Sava Swing components are implemented in the three-dimensional space. It is not required to re-design and re-develop all images, and the existing alarm system image implemented in the two-dimensional plane can be directly inherited, and can be displayed and processed in the three-dimensional space, thereby implementing fast drawing by the component in the three-dimensional space, and introducing multiple alarm images into the three-dimensional space. For the images not implemented, the images are arranged in the two-dimensional plane, and are drawn in the two-dimensional plane by using a dual-buffer mechanism of Java Swing component, and are displayed and processed in the three-dimensional space through the present invention. In comparison with the method for directly drawing in the three-dimensional space, the method of the present invention is easy and convenient.

The three-dimensional man-machine interaction display and control method provided by the present invention is described in detail above. Any obvious modifications made by persons of ordinary skill in the art without departing from the spirit of the present invention constitute infringement of patent of the present invention, and the corresponding legal liability should be borne.

What is claimed is:

1. A three-dimensional man-machine interaction display and control method, comprising the following steps:
drawing a picture in a two-dimensional plane by using a dual-buffer mechanism;
reading the picture drawn in the two-dimensional plane, and drawing the picture in a three-dimensional space;
detecting an interaction event in the three-dimensional space, and determining a type of a component in an operation panel;
delivering the interaction event between the three-dimensional space and the two-dimensional plane, and processing the interaction event according to the component type; and
reading the picture drawn by the component in the two-dimensional plane, and updating a corresponding image in the three-dimensional space.

2. The three-dimensional man-machine interaction display and control method according to claim 1, wherein the step of drawing a picture in a two-dimensional plane by using a dual-buffer mechanism further comprises:
generating a buffer area in a memory according to dimensions of the three-dimensional space;
generating a graphic handle drawn according to a picture in the buffer area; and
drawing a graphic object of the component in the buffer area through the graphic handle.

3. The three-dimensional man-machine interaction display and control method according to claim 1, wherein
the step of drawing a picture in a two-dimensional plane by using a dual-buffer mechanism is implemented by using a dual-buffer mechanism of Java Swing component.

4. The three-dimensional man-machine interaction display and control method according to claim 1, wherein the step of reading the picture drawn in the two-dimensional plane, and drawing the picture in a three-dimensional space further comprises:
reading the picture drawn in the two-dimensional plane in real time by refreshing a thread, and updating image parameters according to dimensions of the three-dimensional space and displaying an image in the three-dimensional space.

5. The three-dimensional man-machine interaction display and control method according to claim 1, wherein the step of detecting an interaction event in the three-dimensional space, and determining a type of a component in an operation panel further comprises:
converting a coordinate in the two-dimensional plane into a coordinate in the three-dimensional space according to a viewport transformation inverse matrix, a projection transformation inverse matrix, and a model transformation inverse matrix;
projecting the coordinate in the three-dimensional space into the two-dimensional plane, and calculating a relative coordinate;
invoking an operation panel in the two-dimensional plane, and calculating the coordinate in the two-dimensional plane according to size of the operation panel in the two-dimensional plane; and
determining a component type according to the coordinate in the two-dimensional plane.

6. The three-dimensional man-machine interaction display and control method according to claim 1, wherein
the component type is one of a button, a radio button, a checkbox, a textbox, a list, a tree, a combo box, a table, or a tool bar.

7. The three-dimensional man-machine interaction display and control method according to claim 1, wherein the step of delivering the interaction event, and processing the interaction event according to the component type further comprises:
delivering the interaction event from the three-dimensional space to the two-dimensional plane according to a type of the interaction event, the calculated relative coordinate, the operation panel in the two-dimensional plane, and the component type;
converting the interaction event into an interaction operation to be performed on the component in the two-dimensional plane;
simulating a corresponding interaction operation in the two-dimensional plane; and
responding to the interaction operation and updating an picture drawn in the two-dimensional plane.

8. The interaction method according to claim 1, wherein the step of reading the picture drawn by the component in the two-dimensional plane, and updating a corresponding image in the three-dimensional space further comprises:
reading the picture drawn in the two-dimensional plane in real time by refreshing a thread, and updating the corresponding image in the three-dimensional space by updating parameters.
